(19) United States
(12) Patent Application Publication
(10) Pub. No.: US 2022/0341265 A1
(43) Pub. Date: Oct. 27, 2022

(54) SELF-MOVING TUBULAR STORAGE RIGS AND METHODS FOR THE USE THEREOF

(71) Applicant: Birch Resources, LLC, Houston, TX (US)

(72) Inventors: Gian F. Callarotti, Katy, TX (US); Colin M. Hornock, Sugarland, TX (US)

(21) Appl. No.: 17/713,166

(22) Filed: Apr. 4, 2022

Related U.S. Application Data
(60) Provisional application No. 63/179,072, filed on Apr. 23, 2021.

(51) Int. Cl. E21B 7/02; E21B 33/06; B62D 57/028

(52) U.S. Cl. CPC E21B 7/023; E21B 33/06; B62D 57/028

(57) ABSTRACT

The present disclosure relates to self-moving tubular storage rigs and methods for the use thereof. A benefit to the self-moving tubular storage rigs herein can be providing time efficient transport and storage of tubulars between work sites on a multi-well pad. Another benefit to the self-moving tubular storage rigs can be providing safer transport of tubulars between work sites in the same multi-well pad. Additional benefits can be a safer work practice as well as significant cost savings associated with the transport of tubulars between work sites on a multi-well pad.

### CROSS-REFERENCE TO RELATED APPLICATIONS

This U.S. Application claims priority to U.S. Provisional 63/179,072, filed on Apr. 23, 2021, the entirety of which is incorporated by reference.

### TECHNICAL FIELD

The present disclosure relates to self-moving tubular storage rigs and methods for the use thereof. A benefit to the self-moving tubular storage rigs herein can be providing time efficient transport and storage of tubulars between work sites on a multi-well pad. Another benefit to the self-moving tubular storage rigs can be providing safer transport of tubulars between work sites in the same multi-well pad. Additional benefits can be a safer work practice as well as significant cost savings associated with the transport of tubulars between work sites on a multi-well pad.

### BACKGROUND

Storage and transport equipment used in workover and drillout operations must often be able to support and move very heavy loads. One example is conventional workover rigs, which must support the weight of drilling tubulars used at well pad worksites. Over the course of operations at a multi-well pad, the tubular work strings are delivered to a work site and installed in a workover rig. While the work is ongoing, the tubulars are stored and racked vertically in the workover rig derrick. As work is completed, the workover rig and tubulars will periodically be transferred to a different work site on the multi-well pad. Current methods of transporting the tubulars involve removing the tubulars from the workover rig by moving them to a horizontal position on a transport vehicle, commonly by means of a V-door and/or a lay down machine. The workover rig and the tubulars are then transported to the next work site. Each time the rig must be moved from one well to the next, the tubulars must be broken down in singles and laid down horizontally on pipe racks, then moved to the next location. Such transfer operations can last up to 24 hours or more, incurring substantial costs as well as resulting in significant downtime. There is a need in the art for equipment and methods that can more efficiently and cost effectively transport tubulars between work sites on multi-well pads.

### SUMMARY

Embodiments herein are directed to self-moving tubular storage rigs for transporting and storing tubulars between work sites of a multi-well pad. In various embodiments, a self-moving tubular storage rig includes: a telescopic derrick having a lower end connected to an upper surface of a base platform; a work platform connected to and adjacent to an end of the base platform; a tubular rack connected to an upper portion of the telescopic derrick; and at least four walking feet connected to a lower surface of the base platform, wherein the work platform is located beneath the tubular rack, wherein the at least four walking feet are capable of transporting the self-moving tubular storage rig.

In an aspect, the self-moving tubular storage rig further includes a derrick actuator connected to the upper surface of the base platform and the telescopic derrick. In certain embodiments, the derrick actuator includes a hydraulic actuator, an electric actuator, a gas-powered actuator, a winch actuator, or a combination thereof In certain embodiments, the self-moving tubular storage rig includes at least two walking feet actuators connected to each walking foot. In certain embodiments, the at least two walking feet actuators include a hydraulic actuator, an electric actuator, a gas-powered actuator, a winch actuator, a linear actuator, a lifting jack, or a combination thereof

Certain embodiments of the self-moving tubular storage rig further include a power pack, a power source, and an operator console. Certain embodiments further include a power pack, a power source, and an operator console located on the upper surface of the base platform. In certain embodiments, the power pack comprises a hydraulic power pack, an electric power pack, or a combination thereof. In certain embodiments, the power source comprises a fuel cell, a fuel tank, or a hydraulic power source. In certain embodiments, the fuel cell has a fuel capacity of from about 500 liters to about 1000 liters; in certain embodiments, the hydraulic power source has a force capacity of from about 6,500 kPa to about 13,500 kPa. In certain embodiments, the operator console contains at least one of manual controls, a display, a transmitter, and a receiver.

Some embodiments of the self-moving tubular storage rig further include at least one blowout preventer (BOP) lifting mechanism connected to the base platform. In certain embodiments, the BOP lifting mechanism includes a forklift, a two-prong forklift, or a hydraulic forklift.

Certain embodiments include at least one wheel connected to the lower surface of the base platform. In certain embodiments, the base platform comprises a vehicle flatbed. In certain embodiments, the base platform is connected to a towing hitch, a mounting bracket, or is capable of being mounted on or connected to a vehicle.

In various embodiments of the self-moving tubular storage rig, the work platform and tubular rack are configured to hold or are capable of holding one or more tubulars, the tubulars having a tubular upper portion and a tubular lower end. In various embodiments, the work platform contacts the tubular lower end and is capable of bearing the weight of the tubular, and the tubular rack is capable of holding the tubular upper portion in a substantially vertical position relative to the base platform. In certain embodiments, the tubular rack is configured to or capable of holding tubulars having an external diameter of from about 3 cm to about 5 cm. In certain embodiments, the tubular rack is a monkey board having prongs with an inter-prong spacing of from about 6 cm to about 10 cm. In certain embodiments, the tubular rack is positioned a distance of about 7.5 m about 22 m above the work platform.

In certain embodiments, the telescopic derrick has an extended height of from about 21 m to about 28 m; in certain embodiments, the telescopic derrick has a retracted height of from about 9 m to about 12.5 m. In certain embodiments, the base platform has a length of from about 12 m to about 20 m or a width of from about 2 m to about 4 m.

In certain embodiments, the work platform is formed from a steel material or a stainless-steel material. In certain embodiments, the work platform has a length of from about 1.5 m to about 5 m, a width of from about 1.5 m to about 5 m, and a thickness of from about 3.5 cm to about 6.5 cm. In certain embodiments, the work platform has a weight bearing capacity of about 100,000 kg to about 150,000 kg.

In certain embodiments, the self-moving tubular storage rig has a weight of from about 20,000 kg to about 40,000 kg. In certain embodiments, the power pack and the fuel cell are disposed on the upper surface of the base platform at a horizontal distance of from about 6 m to about 12 m from the lower end of the telescopic derrick.

In some aspects, the self-moving tubular storage rig further includes at least one counterweight connected to the base platform at a horizontal distance of from about 6 m to about 12 m from the lower end of the telescopic derrick, wherein the at least one counterweight has a weight of from about 30,000 kg to about 50,000 kg.

Embodiments of methods of transferring tubulars between work sites are disclosed herein. In an embodiment, the method includes: providing a workover rig located on a first work site, wherein the workover rig is loaded with one or more tubulars; transporting a self-moving tubular storage rig to the first work site, the walking tubular storage rig including: a telescopic derrick having a lower end connected to an upper surface of a base platform; a work platform connected to and adjacent to an end of the base platform; a tubular rack connected to an upper portion of the telescopic derrick; and at least four walking feet connected to a lower surface of the base platform, wherein the work platform is located beneath the tubular rack, wherein the at least four walking feet are capable of moving the self-moving tubular storage rig, transferring the one or more tubulars from the workover rig to the self-moving tubular storage rig, while maintaining the one or more tubulars in a substantially vertical position relative to the working platform of the self-moving tubular storage rig; and transporting the one or more tubulars by operation of the at least four walking feet of the self-moving tubular storage rig.

In certain embodiments, a distance between the first work site and the second work site is from about 5 m to about 50 m. In certain embodiments, the first work site and the second work site are located on the same multi-well pad. In certain embodiments, the first work site and the second work site are adjacent.

Certain embodiments of the method further include transporting the self-moving tubular storage rig to the first work site by attaching the self-moving tubular storage rig to a vehicle and driving the self-moving tubular storage rig from a remote location to the first worksite.

In certain embodied methods, the one or more tubulars have a tubular upper portion that terminates in a tubing joint; in certain embodiments, the one or more tubulars include at least two segments connected by a tubing joint. In certain embodiments, the one or more tubulars include an oilfield pipe, a drill pipe, a casing, production tubing, a pipeline, a drill string, or a combination thereof In certain embodiments, the one or more tubulars have an external diameter of from about 5 cm to about 13 cm; in certain embodiments, the one or more tubulars have a segment length of from about 7.5 m to about 11 m; in certain embodiments, the one or more tubulars have a total length of from about 15 m to about 22 m.

### BRIEF DESCRIPTION OF THE DRAWINGS

The foregoing summary, as well as the following detailed description of the embodiments, will be better understood when read in conjunction with the attached drawings. For the purpose of illustration, there are shown in the drawings some embodiments, which may be preferable. It should be understood that the embodiments depicted are not limited to the precise details shown. Unless otherwise noted, the drawings are not to scale.

FIG. 1 shows a schematic side view of a self-moving tubular storage rig according to an embodiment, as discussed herein.

FIG. 2 shows a schematic side view of a workover rig and a self-moving tubular storage rig according to an embodiment, as discussed herein.

FIG. 3 is a flow chart illustrating a method of transferring tubulars between work sites according to an embodiment, as discussed herein.

### DETAILED DESCRIPTION

Unless otherwise noted, all measurements are in standard metric units.

Unless otherwise noted, all instances of the words “a,” “an,” or “the” can refer to one or more than one of the word that they modify.

Unless otherwise noted, the phrase “at least one of” means one or more than one of an object. For example, “at least one of manual controls, a display, a transmitter, and a receiver” means one or more than one manual controls, one or more than one displays, one or more than one transmitters, one or more than one receiver, or any combination thereof.

Unless otherwise noted, the term “about” refers to ±10% of the non-percentage number that is described, rounded to the nearest whole integer. For example, about 20 m, would include 18 to 22 m. Unless otherwise noted, the term “about” refers to ±5% of a percentage number. For example, about 20% would include 15 to 25%. When the term “about” is discussed in terms of a range, then the term refers to the appropriate amount less than the lower limit and more than the upper limit. For example, from about 100,000 kg to about 150,000 kg would include from 90,000 to 165,000 kg.

Unless otherwise noted, properties (height, width, length, ratio etc.) as described herein are understood to be averaged measurements.

Unless otherwise noted, the terms “provide”, “provided” or “providing” refer to the supply, production, purchase, manufacture, assembly, formation, selection, configuration, conversion, introduction, addition, or incorporation of any element, amount, component, reagent, quantity, measurement, or analysis of any method or system of any embodiment herein.

Unless otherwise noted, the term “workover rig” means a mobile, self-propelled rig, such as a workover unit, used to perform one or more remedial operations on a producing oil or gas well intended to restore or increase the well's production; among such operations, workover units are used to drill out frac plugs used during hydraulic fracturing.

Unless otherwise noted, the term “substantially vertical” refers to the majority of the tubulars having a longest length that is within 20 degrees of being perpendicular to the ground.

Unless otherwise noted, the term “substantially horizontal” refers to the majority of the tubulars having a longest length that is within 20 degrees of being parallel to the ground.

### Self-Moving Tubular Storage Rigs of Various Embodiments

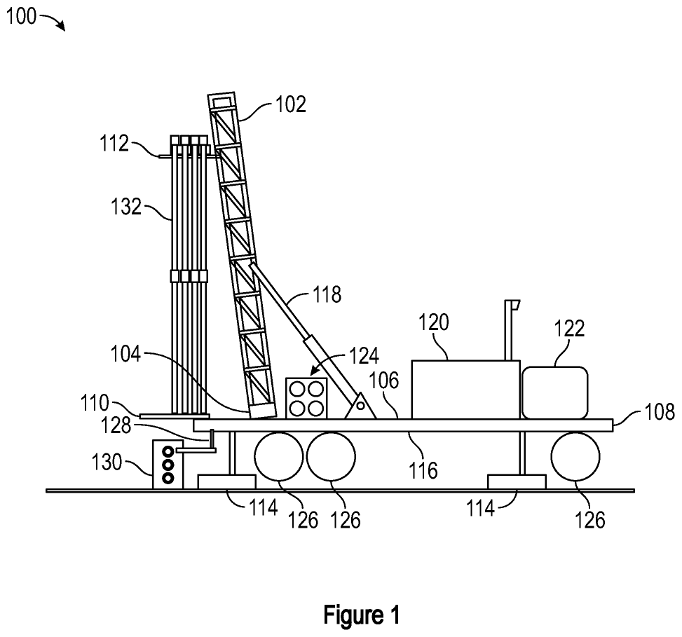

Embodiments herein are directed to self-moving tubular storage rigs. In an embodiment of a self-moving tubular storage rig herein, referring to FIG. 1, self-moving tubular storage rig 100 includes telescopic derrick 102 having lower end 104 connected to upper surface 106 of base platform 108; work platform 110 connected to and adjacent to an end of base platform 108 and located beneath tubular rack 112 connected to an upper portion of telescopic derrick 102; walking feet 114 connected to a lower surface 116 of based platform 108; and derrick actuator 118 connected to upper surface 106 of base platform 108 and telescopic derrick 102. Self-moving tubular storage rig 100 includes power pack 120, power source 122, and operator console 124 located on upper surface 106 of base platform 108; wheels 126 connected to lower surface 116 of base platform 108; and blowout preventer (BOP) lifting mechanism 128 connected to base platform 108. BOP 130 can be carried by a BOP lifting mechanism 128. Tubulars 132 are held by work platform 110 and tubular rack 112.

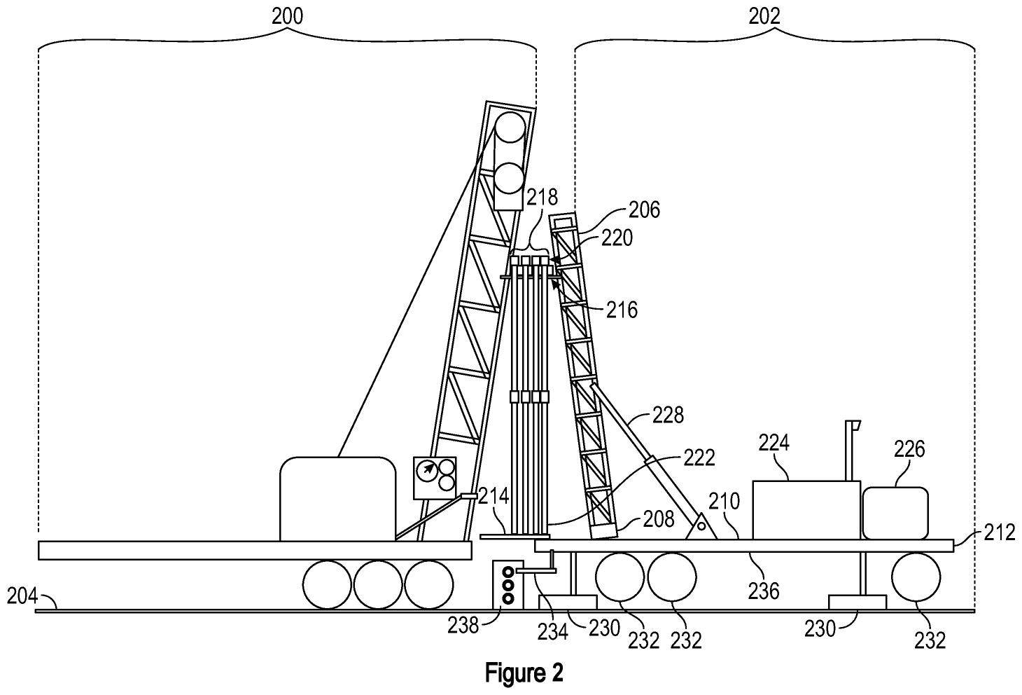

Embodiments herein are directed to self-moving tubular storage rigs for transporting and storing tubulars between work sites of a multi-well pad. In an embodiment herein, referring to FIG. 2, workover rig 200 and self-moving tubular storage rig 202 are shown on wellsite pad 204. Self-moving tubular storage rig 202 includes telescopic derrick 206 having lower end 208 connected to upper surface 210 of base platform 212; work platform 214 connected to and adjacent to an end of base platform 212 and located beneath tubular rack 216 connected to an upper portion of telescopic derrick 206. Tubulars 218 have a tubular upper portions 220 and a tubular lower ends 222, wherein work platform 214 contacts tubular lower ends 222 and is capable of bearing the weight of tubulars 218; wherein tubular rack 216 holds tubular upper portions 220 in a substantially vertical position relative to base platform 212. Self-moving tubular storage rig 202 includes power pack 224, power source 226, and derrick actuator 228 connected to upper surface 210 of base platform 212, derrick actuator 228 being connected to telescopic derrick 206; walking feet 230 and wheels 232 connected to lower surface 236 of base platform 212; blowout preventer (BOP) lifting mechanism 234 connected to base platform 212; and BOP 238 connected to BOP lifting mechanism 234.

Drilling multiple wells at a single location is an established way to reduce the overall costs of drilling operations. Conventional workover rigs are widely used after drilling operations at multi-well pads. Because workover rigs can include a walking function, the cost per well can be dramatically reduced by the ability to move the drilling rigs between work sites, since there is no need to dismantle a rig, transport the components, and assemble the rig again in the new location. Even with a walking rig, however, moving an entire rig that can weigh over 500,000 pounds leaves very little margin for error. While the workover rig is rigged down and driven to the next well, tubulars that are racked on the rig must be moved separately from the rig, and reinstalled on the rig at the new location. At other times, it may be desired to transfer the tubulars from one workover rig to another rig at an adjacent worksite. Current methods for transferring the tubulars involve moving them onto a separate transport vehicle. Each tubular in the work string must be transferred from a vertical position to a horizontal position onto pipe racks on the transport vehicle, transported to the new location, and then transferred from the horizontal position to a vertical position for reinstallation. This type of operation is commonly performed by means of a V-door and/or a lay down machine. Such transfer operations can last up to 24 hours or more, resulting in very costly drillout operation downtime. Also, considering the heavy weight of the tubulars, the transfer operation presents substantial safety risks even to highly trained personnel. Moving the tubulars to a horizontal position takes up a great deal of lateral space as well, presenting challenges for maneuverability of the transport vehicle on the pad, and adding to the overall difficulty of the operation. The transport vehicles required for transfer of the tubulars are often hired on a hourly basis, further adding to the costs. When added together, the costs and safety risk are enormous even though the tubular may only be moved to the next new work site on the same-pad.

There is a need for equipment and methods that can more efficiently, more safely, and more cost effectively transport tubulars between work sites on multi-well pads.

The self-moving tubular storage rigs herein can provide a self-moving capability together with a tubular rack and a work platform for the efficient and cost-effective transport and storage of tubulars. Such embodiments can also provide a benefit of improved safety for tubular transport operations. Embodiments herein are directed to self-moving tubular storage rigs for transporting and storing tubulars between work sites of a multi-well pad. In various embodiments, a self-moving tubular storage rig includes: a telescopic derrick having a lower end connected to an upper surface of a base platform. In various embodiments, a self-moving tubular storage rig includes a work platform connected to and adjacent to an end of the base platform. In various embodiments, a self-moving tubular storage rig includes a tubular rack connected to an upper portion of the telescopic derrick. In various embodiments, a self-moving tubular storage rig includes at least four walking feet connected to a lower surface of the base platform. In various embodiments, a self-moving tubular storage rig the work platform is located beneath the tubular rack and/or the at least four walking feet are capable of transporting the self-moving tubular storage rig.

In an aspect, the self-moving tubular storage rig further includes a derrick actuator connected to the upper surface of the base platform and the telescopic derrick. The derrick actuator can control the movement of the derrick, and allow the derrick to move laterally, to cant up and down, and to extend and retract. In certain embodiments, the derrick actuator includes a hydraulic actuator, an electric actuator, a gas-powered actuator, a winch actuator, or a combination thereof In certain embodiments, the self-moving tubular storage rig includes at least two walking feet actuators connected to each walking foot. The walking feet actuators can enable the walking function of the self-moving rig. In certain embodiments, the at least two walking feet actuators include a hydraulic actuator, an electric actuator, a gas-powered actuator, a winch actuator, a linear actuator, a lifting jack, or a combination thereof In various embodiments, the at least four walking feet can be of a sufficient size, width, and weight in order to stabilize the self-moving tubular storage rig, while allowing the walking function of the rig.

Certain embodiments of the self-moving tubular storage rig further include a power pack, a power source, and an operator console. Certain embodiments further include a power pack, a power source, and an operator console located on the upper surface of the base platform. The power pack and the power source can provide power for the self-moving function of the rig. In certain embodiments, the power pack comprises a hydraulic power pack, an electric power pack, or a combination thereof In certain embodiments, the power source comprises a fuel cell, a fuel tank, or a hydraulic power source. In certain embodiments, the fuel cell has a fuel capacity of from about 500 liters to about 1000 liters. In certain embodiments, the fuel cell has a fuel capacity of from about 600 liters to about 900 liters. In certain embodiments, the fuel cell has a fuel capacity of from about 700 liters to about 800 liters. In certain embodiments, the hydraulic power source has a force capacity of from about 6,500 kPa to about 13,500 kPa. In certain embodiments, the hydraulic power source has a force capacity of from about 8,000 kPa to about 12,000 kPa. In certain embodiments, the hydraulic power source has a force capacity of from about 9,000 kPa to about 10,000 kPa. In certain embodiments, the operator console contains at least one of manual controls, a display, a transmitter, and a receiver. Embodiments of the operator console can allow manual control operation of the self-moving tubular storage rig, or remote control operation.

Some embodiments of the self-moving tubular storage rig further include at least one blowout preventer (BOP) lifting mechanism connected to the base platform. In certain embodiments, the BOP lifting mechanism includes a forklift, a two-prong forklift, or a hydraulic forklift. The BOP lifting mechanism is not needed for the transportation or storage of tubulars. However, such embodiments can provide a benefit of a capability of lifting and transporting a BOP plus a capability of transporting tubulars. The BOP lifting mechanism can thus provide benefits of greater efficiency and safety for operations requiring transport of a BOP and tubulars, by avoiding a necessity of transporting them separately.

Certain embodiments include at least one wheel connected to the lower surface of the base platform. The one or more wheels can facilitate the movement of the rig across a multi-well pad surface. In certain embodiments, the base platform comprises a vehicle flatbed. In certain embodiments, the base platform is connected to a towing hitch, a mounting bracket, or is capable of being mounted on or connected to a vehicle. Such embodiments can provide a benefit of versatility for the transport of the self-moving tubular storage rig between work sites on a multi-well pad, or transport of the rig over greater distances between multi-well pads, or transport of the rig over road surfaces to reach a multi-well pad.

In various embodiments of the self-moving tubular storage rig, the work platform and tubular rack are configured to hold or are capable of holding one or more tubulars, the tubulars having a tubular upper portion and a tubular lower end. In conventional drilling derricks a work platform cannot and does not need to support the weight of tubulars. In contrast, in various embodiments, the work platform is located beneath the tubular rack, contacts the tubular lower end, and is capable of bearing the weight of the tubulars. In various embodiments, the tubular rack is capable of holding the tubular upper portion in a substantially vertical position relative to the base platform. Such embodiments can provide a benefit of holding and transporting one or more tubulars while in a substantially vertical position. Such embodiments can provide substantial advantages over conventional methods of transporting tubulars that require transferring the tubulars to a horizontal position before transport, then returning the tubulars to a substantially vertical position again at the next work site. Such embodiments can provide benefits of substantial time and cost savings over conventional methods, as well as greater maneuverability of the self-moving rig and greater personnel safety compared to conventional methods.

Embodiments of the self-moving tubular storage rig can accommodate the storage and transport of a variety of types, diameters and lengths of tubulars that may be used in multi-well pad operations. In certain embodiments, the tubular rack is configured to or capable of holding tubulars having an external diameter of from about 3 cm to about 5 cm. In certain embodiments, the tubular rack is configured to or capable of holding tubulars having an external diameter of from about 3.4 cm to about 4.6 cm. In certain embodiments, the tubular rack is configured to or capable of holding tubulars having an external diameter of from about 3.8 cm to about 4.2 cm. In certain embodiments, the tubular rack is a monkey board having prongs, or “fingers”, with an inter-prong spacing of from about 6 cm to about 10 cm. In certain embodiments, the tubular rack is a monkey board having prongs with an inter-prong spacing of from about 6.5 cm to about 9.5 cm. In certain embodiments, the tubular rack is a monkey board having prongs with an inter-prong spacing of from about 7.5 cm to about 8.5 cm. In certain embodiments, the tubular rack is positioned a distance of about 7.5 m about 22 m above the work platform. In certain embodiments, the tubular rack is positioned a distance of about 10 m about 18 m above the work platform. In certain embodiments, the tubular rack is positioned a distance of about 14 m about 16 m above the work platform.

Embodiments of a telescoping derrick of the self-moving tubular storage rig can allow the storage and transport of a variety of lengths of tubulars that may be used in multi well pad operations. In certain embodiments, the telescopic derrick has an extended height of from about 21 m to about 28 m. In certain embodiments, the telescopic derrick has an extended height of from about 22 m to about 27 m. In certain embodiments, the telescopic derrick has an extended height of from about 23 m to about 26 m. In certain embodiments, the telescopic derrick has a retracted height of from about 9 m to about 12.5 m. In certain embodiments, the telescopic derrick has a retracted height of from about 9.5 m to about 12 m. In certain embodiments, the telescopic derrick has a retracted height of from about 10 m to about 11 m.

Embodiments of a base platform of the self-moving tubular storage rig can have a length and width that can provide for maneuverability of the rig between work sites, while providing for stability of the rig for storing and transporting tubulars in a substantially vertical position relative to the base platform. In certain embodiments, the base platform has a length of from about 12 m to about 20 m. In certain embodiments, the base platform has a length of from about 14 m to about 18 m. In certain embodiments, the base platform has a length of from about 16 m to about 17 m. In certain embodiments, the base platform has a width of from about 2 m to about 4 m. In certain embodiments, the base platform has a width of from about 2.4 m to about 3.6 m. In certain embodiments, the base platform has a width of from about 2.8 m to about 3.2 m.

Embodiments of a work platform of the self-moving tubular storage rig can have a length, width, thickness, and weight bearing capacity that can provide for the transportation and storage of a number and variety of tubulars that may be used in multi-well pad operations. Such embodiments can provide benefits of bearing the weight of one or more tubulars and contacting and supporting the lower ends of one or more tubulars. In certain embodiments, the work platform is formed from a steel material or a stainless-steel material. In certain embodiments, the work platform has a length of from about 1.5 m to about 5 m. In certain embodiments, the work platform has a length of from about 2 m to about 4 m. In certain embodiments, the work platform has a length of from about 2.5 m to about 3.5 m. In certain embodiments, the work platform has a width of from about 1.5 m to about 5 m. In certain embodiments, the work platform has a width of from about 2 m to about 4 m. In certain embodiments, the work platform has a width of from about 2.5 m to about 3.5 m. In certain embodiments, the work platform has a thickness of from about 3.5 cm to about 6.5 cm. In certain embodiments, the work platform has a thickness of from about 4.0 cm to about 6.0 cm. In certain embodiments, the work platform has a thickness of from about 4.5 cm to about 5.5 cm. In various embodiments, the work platform is connected to and adjacent to an end of the base platform. In some embodiments, the work platform can be connected to an upper surface of the base platform and adjacent to an end of the base platform. In some embodiments, the work platform can be connected to an end of the base platform, or connected to a lower surface of the base platform and adjacent to an end of the base platform.

In certain embodiments, the work platform has a weight bearing capacity of at least 100% of the weight of one or more tubulars to be transported or stored by the self-moving tubular storage rig. In certain embodiments, the work platform has a weight bearing capacity of about 100,000 kg to about 150,000 kg. In certain embodiments, the work platform has a weight bearing capacity of about 110,000 kg to about 140,000 kg. In certain embodiments, the work platform has a weight bearing capacity of about 120,000 kg to about 130,000 kg.

In various embodiments of a self-moving tubular storage rig, the rig can have a weight that allows for self-movement and maneuverability of the rig, while providing a benefit of transporting and storing tubulars between work sites in a substantially vertical position relative to the base platform. In certain embodiments, the self-moving tubular storage rig has a weight of from about 20,000 kg to about 40,000 kg.

Embodiments of a self-moving tubular storage rig including a power pack and a fuel cell can provide a benefit of allowing the placement of the power pack and the fuel cell on the base platform so as to increase the stability of the rig for transporting and storing tubulars. In certain embodiments, the power pack and the fuel cell are disposed on the upper surface of the base platform at a horizontal distance of from about 6 m to about 12 m from the lower end of the telescopic derrick. In certain embodiments, the power pack and the fuel cell are disposed on the upper surface of the base platform at a horizontal distance of from about 7 m to about 11 m from the lower end of the telescopic derrick. In certain embodiments, the power pack and the fuel cell are disposed on the upper surface of the base platform at a horizontal distance of from about 8 m to about 10 m from the lower end of the telescopic derrick. Such embodiments can provide a benefit of helping to counterbalance the weight of the tubulars being stored or transported by the rig.

Some embodiments of a self-moving tubular storage rig include at least one counterweight connected to the base platform. Such embodiments can have a benefit of adding greater stability to the rig, in order to counterbalance the weight of the tubulars being stored or transported by the rig. In various embodiments, the at least one counterweight can be connected to the base platform at a horizontal distance from the telescopic derrick, at a distance that can be chosen to provide the needed counterbalancing of the tubular weight. In some aspects, the self-moving tubular storage rig further includes at least one counterweight connected to the base platform at a horizontal distance of from about 6 m to about 12 m from the lower end of the telescopic derrick. In some aspects, the self-moving tubular storage rig further includes at least one counterweight connected to the base platform at a horizontal distance of from about 7 m to about 11 m from the lower end of the telescopic derrick. In some aspects, the self-moving tubular storage rig further includes at least one counterweight connected to the base platform at a horizontal distance of from about 8 m to about 10 m from the lower end of the telescopic derrick. In various embodiments, the weight of the at least one counterweight can be chosen to provide the needed counterbalancing of the tubular weight. In an embodiment, the at least one counterweight has a weight of from about 30,000 kg to about 50,000 kg. In an embodiment, the at least one counterweight has a weight of from about 35,000 kg to about 45,000 kg. In an embodiment, the at least one counterweight has a weight of from about 38,000 kg to about 42,000 kg. In some embodiments, the connection of the at least one counterweight to the base platform can be reversible or adjustable, to allow adaptation of the number or placement of the counterweights to provide the desired counterbalancing of the tubular weight. Such embodiments can provide a benefit of greater versatility of the self-moving tubular storage rig for a variety of tubular transport and storage needs.

### Methods of Transferring Tubulars between Work Sites of Various Embodiments

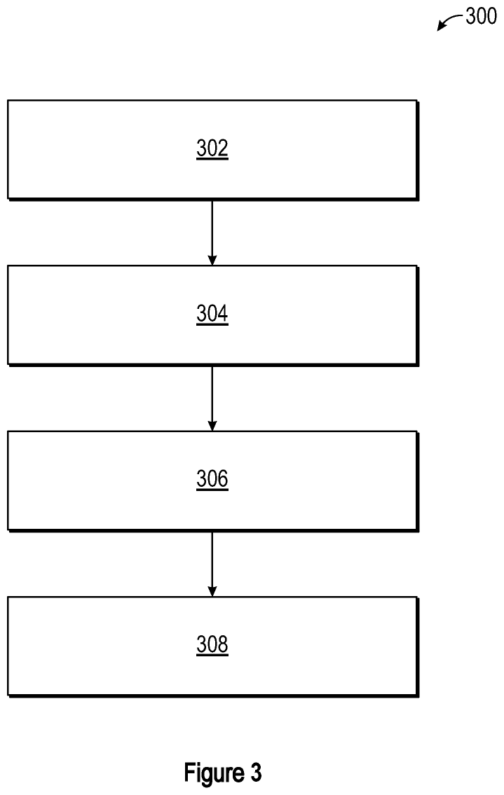

Embodiments of methods of transferring tubulars between work sites are disclosed herein. In an embodiment of a method, referring to FIG. 3, method 300 includes providing a workover rig located on a first work site, wherein the workover rig is loaded with one or more tubulars 302; transporting a self-moving tubular storage rig to the first work site 304; transferring the one or more tubulars from the workover rig to the self-moving tubular storage rig, while maintaining the one or more tubulars in a substantially vertical position relative to the working platform of the self-moving tubular storage rig 306; and transporting the one or more tubulars by operation of the walking feet of self-moving tubular storage rig 308.

Embodiments of methods of transferring tubulars between work sites are disclosed herein. In an embodiment, the method includes: providing a workover rig located on a first work site, wherein the workover rig is loaded with one or more tubulars. In an embodiment, the method includes: transporting a self-moving tubular storage rig to the first work site, the walking tubular storage rig including: a telescopic derrick having a lower end connected to an upper surface of a base platform; a work platform connected to and adjacent to an end of the base platform; a tubular rack connected to an upper portion of the telescopic derrick; and at least four walking feet connected to a lower surface of the base platform, wherein the work platform is located beneath the tubular rack, wherein the at least four walking feet are capable of moving the self-moving tubular storage rig, transferring the one or more tubulars from the workover rig to the self-moving tubular storage rig, while maintaining the one or more tubulars in a substantially vertical position relative to the working platform of the self-moving tubular storage rig; and transporting the one or more tubulars by operation of the at least four walking feet of the self-moving tubular storage rig.

Conventional workover rigs usually have non-weight bearing work platforms and an elevated platform or monkey board. These features of a conventional workover rig would prevent or make it difficult to transfer tubulars from the conventional workover rig to the self-moving tubular storage rig. In certain embodiments, the conventional workover rig is modified by removing the workover rig work platform and elevated platform or monkey board, in order to facilitate either transferring one or more tubulars from the workover rig to the self-moving tubular storage rig, or transferring one or more tubulars from the self-moving tubular storage rig onto the workover rig.

By avoiding the necessity of transferring the tubulars to a horizontal position before transport, then returning the tubulars to a substantially vertical position at the next work site, such embodiments can provide substantial advantages of time and cost savings over conventional methods of transporting tubulars. Such embodiments can also provide a benefit of greater personnel safety compared to conventional methods, by allowing the transfer of tubulars from a workover rig to a self-moving tubular storage rig while maintaining the tubulars in a substantially vertical position. Such embodiments can also provide a benefit of greater maneuverability of the self-moving tubular storage rig compared to the use of conventional tubular transport vehicles, by requiring less horizontal space for their respective operations.

Embodiments of methods herein can provide a benefit of an ability to transport tubulars over a variety of distances between work sites, or between multi-well pads. In certain embodiments, a distance between the first work site and the second work site is from about 5 m to about 50 m. In certain embodiments, a distance between the first work site and the second work site is from about 10 m to about 40 m. In certain embodiments, a distance between the first work site and the second work site is from about 20 m to about 30 m. In certain embodiments, the first work site and the second work site are located on the same multi-well pad. In certain embodiments, the first work site and the second work site are adjacent. Certain embodiments of the method further include transporting the self-moving tubular storage rig to the first work site by attaching the self-moving tubular storage rig to a vehicle and driving the self-moving tubular storage rig from a remote location to the first worksite.

Embodiments of methods herein can provide a benefit of an ability to store and transport a variety of types, diameters and lengths of tubulars that may be used in multi-well pad operations. In certain embodied methods, the one or more tubulars have a tubular upper portion that terminates in a tubing joint; in certain embodiments, the one or more tubulars include at least two segments connected by a tubing joint. In certain embodiments, the one or more tubulars include an oilfield pipe, a drill pipe, a casing, production tubing, a pipeline, a drill string, or a combination thereof In certain embodiments, the one or more tubulars have an external diameter of from about 5 cm to about 13 cm. In certain embodiments, the one or more tubulars have an external diameter of from about 7 cm to about 12 cm. In certain embodiments, the one or more tubulars have an external diameter of from about 8 cm to about 10 cm. In certain embodiments, the one or more tubulars have a segment length of from about 7.5 m to about 11 m. In certain embodiments, the one or more tubulars have a segment length of from about 8 m to about 10.5 m. In certain embodiments, the one or more tubulars have a segment length of from about 9 m to about 10 m. In certain embodiments, the one or more tubulars have a total length of from about 15 m to about 22 m. In certain embodiments, the one or more tubulars have a total length of from about 16 m to about 21 m. In certain embodiments, the one or more tubulars have a total length of from about 18 m to about 20 m.

### EXAMPLES

A self-moving tubular storage rig will be constructed with a capability of storing a tubular work string vertically in doubles, and that will include a walking package similar to systems found in unconventional drilling rigs. The system will include:

A telescopic, abatable derrick with an elevated platform or monkey board to rack the tubulars.

A work platform or rig floor will be constructed of steel, having dimensions and a weight of about 5 m×5 m and 1,000 kg respectively.

A hydraulic system to lift a blowout preventer and transport it to the next well.

A hydraulic power source together with a suitable electrical system, and fuel tanks to be walked from well to well.

The self-moving storage rig will be mounted on a wheeled platform that can be pulled by a regular tractor trailer truck.

What is claimed is:

1. A self-moving tubular storage rig for transporting and storing tubulars between work sites of a multi-well pad, comprising:
a telescopic derrick having a lower end connected to an upper surface of a base platform;
a work platform connected to and adjacent to an end of the base platform;
a tubular rack connected to an upper portion of the telescopic derrick; and
at least four walking feet connected to a lower surface of the base platform,
wherein the work platform is located beneath the tubular rack,
wherein the at least four walking feet are capable of transporting the self-moving tubular storage rig.

2. The self-moving tubular storage rig of claim 1, further comprising a derrick actuator connected to the upper surface of the base platform and the telescopic derrick, and at least two walking feet actuators connected to each walking foot.

3. The self-moving tubular storage rig of claim 2, wherein the derrick actuator comprises a hydraulic actuator, an electric actuator, a gas-powered actuator, a winch actuator, or a combination thereof; or
wherein the at least two walking feet actuators comprise a hydraulic actuator, an electric actuator, a gas-powered actuator, a winch actuator, a linear actuator, a lifting jack, or a combination thereof.

4. The self-moving tubular storage rig of claim 1, further comprising a power pack, a power source, and an operator console.

5. The self-moving tubular storage rig of claim 1, further comprising a power pack, a power source, and an operator console located on the upper surface of the base platform, wherein the power pack comprises a hydraulic power pack, an electric power pack, or a combination thereof wherein the power source comprises a fuel cell, a fuel tank, or a hydraulic power source; or wherein the operator console contains at least one of manual controls, a display, a transmitter, and a receiver.

6. The self-moving tubular storage rig of claim 1, further comprising at least one blowout preventer (BOP) lifting mechanism connected to the base platform; or
at least one wheel connected to the lower surface of the base platform.

7. The self-moving tubular storage rig of claim 6, wherein the base platform comprises a vehicle flatbed, or wherein the base platform is connected to a towing hitch, a mounting bracket, or is capable of being mounted on or connected to a vehicle.

8. The self-moving tubular storage rig of claim 1, wherein the work platform and tubular rack are configured to hold or are capable of holding one or more tubulars, the tubulars having a tubular upper portion and a tubular lower end,
wherein the work platform contacts the tubular lower end and is capable of bearing the weight of the tubular, and the tubular rack is capable of holding the tubular upper portion in a substantially vertical position relative to the base platform.

9. The self-moving tubular storage rig of claim 8, wherein the tubular rack is configured to or capable of holding tubulars having an external diameter of from about 3 cm to about 5 cm; or
wherein the tubular rack is a monkey board having prongs with an inter-prong spacing of from about 6 cm to about 10 cm; or
wherein the tubular rack is positioned a distance of about 7.5 m about 22 m above the work platform.

10. The self-moving tubular storage rig of claim 1, wherein the telescopic derrick has an extended height of from about 21 m to about 28 m or a retracted height of from about 9 m to about 12.5 m; or
the base platform has a length of from about 12 m to about 20 m or a width of from about 2 m to about 4 m.

11. The self-moving tubular storage rig of claim 1, wherein the work platform is formed from a steel material or a stainless-steel material; or
wherein the work platform has a length of from about 1.5 m to about 5 m, a width of from about 1.5 m to about 5 m, and a thickness of from about 3.5 cm to about 6.5 cm; or wherein the work platform has a weight bearing capacity of about 100,000 kg to about 150,000 kg.

12. The self-moving tubular storage rig of claim 6, wherein the BOP lifting mechanism comprises a forklift, a two-prong forklift, or a hydraulic forklift; or wherein the BOP lifting mechanism is connected to the base platform.

13. The self-moving tubular storage rig of claim 5, wherein the fuel cell has a fuel capacity of from about 500 liters to about 1000 liters; or wherein the hydraulic power source has a force capacity of from about 6,500 kPa to about 13,500 kPa.

14. The self-moving tubular storage rig of claim 5, wherein the self-moving tubular storage rig has a weight of from about 20,000 kg to about 40,000 kg; or wherein the power pack and the fuel cell are disposed on the upper surface of the base platform at a horizontal distance of from about 6 m to about 12 m from the lower end of the telescopic derrick.

15. The self-moving tubular storage rig of claim 5, further comprising at least one counterweight connected to the base platform at a horizontal distance of from about 6 m to about 12 m from the lower end of the telescopic derrick, wherein the at least one counterweight has a weight of from about 30,000 kg to about 50,000 kg.

16. A method of transferring tubulars between work sites comprising:
providing a workover rig located on a first work site, wherein the workover rig is loaded with one or more tubulars;
transporting a self-moving tubular storage rig to the first work site, the walking tubular storage rig comprising,
a telescopic derrick having a lower end connected to an upper surface of a base platform;
a work platform connected to and adjacent to an end of the base platform;
a tubular rack connected to an upper portion of the telescopic derrick; and
at least four walking feet connected to a lower surface of the base platform,
wherein the work platform is located beneath the tubular rack,
wherein the at least four walking feet are capable of moving the self-moving tubular storage rig,
transferring the one or more tubulars from the workover rig to the self-moving tubular storage rig, while maintaining the one or more tubulars in a substantially vertical position relative to the working platform of the self-moving tubular storage rig; and
transporting the one or more tubulars by operation of the at least four walking feet of the self-moving tubular storage rig.

17. The method of claim 16, wherein a distance between the first work site and the second work site is from about 5 m to about 50 m, or wherein the first work site and the second work site are located on the same multi-well pad, or wherein the first work site and the second work site are adjacent.

18. The method of claim 16, further comprising transporting the self-moving tubular storage rig to the first work site by attaching the self-moving tubular storage rig to a vehicle and driving the self-moving tubular storage rig from a remote location to the first worksite.

19. The method of claim 16, wherein the one or more tubulars have a tubular upper portion that terminates in a tubing joint, or wherein the one or more tubulars comprise at least two segments connected by a tubing joint, or wherein the one or more tubulars comprises an oilfield pipe, a drill pipe, a casing, production tubing, a pipeline, a drill string, or a combination thereof

20. The method of claim 16, wherein the one or more tubulars have an external diameter of from about 5 cm to about 13 cm, or a segment length of from about 7.5 m to about 11 m, or a total length of from about 15 m to about 22 m.
